(19) United States
(12) Patent Application Publication
(10) Pub. No.: US 2023/0411750 A1
(43) Pub. Date: Dec. 21, 2023

(54) SECONDARY BATTERY, APPARATUS FOR PROCESSING SECONDARY DEVICE AND METHOD OF MANUFACTURING SECONDARY BATTERY

(71) Applicant: SK ON CO., LTD., Seoul (KR)

(72) Inventors: Taek Eon JEONG, Daejeon (KR); Dong Ju KIM, Daejeon (KR); Sang Mo KIM, Daejeon (KR); Sun Min PARK, Daejeon (KR); Seung Won CHOI, Daejeon (KR); Ju Won HWANG, Daejeon (KR)

(21) Appl. No.: 18/326,000

(22) Filed: May 31, 2023

(30) Foreign Application Priority Data
Jun. 8, 2022 (KR) 10-2022-0069673

(51) Int. Cl. H01M 50/188; H01M 50/184; H01M 50/193; H01M 10/04; H01M 50/178; H01M 50/105

(52) U.S. Cl. CPC H01M 50/188; H01M 50/184; H01M 50/105; H01M 10/0404; H01M 50/178; H01M 50/193

(57) ABSTRACT

A secondary battery, an apparatus for processing the secondary battery and a method of manufacturing the secondary battery are provided. The secondary battery includes an electrode assembly including an electrode tab, and an exterior material accommodating the electrode assembly and including a sealing portion formed around the electrode assembly. The sealing portion includes a tab sealing portion formed at an area where the electrode tab is drawn out, and the tap sealing portion includes repeating patterns.

### CROSS-REFERENCE TO RELATED APPLICATION AND CLAIM OF PRIORITY

This application claims priority to Korean Patent Applications No. 10-2022-0069673 filed on Jun. 8, 2022 in the Korean Intellectual Property Office (KIPO), the entire disclosure of which is incorporated by reference herein.

### BACKGROUND

### 1. Field

The disclosures of this patent application relates to a secondary battery, an apparatus for processing a secondary battery and a method of manufacturing a secondary battery. More particularly, the disclosures relates to a secondary battery including a sealing portion, an apparatus for processing the same and a method of manufacturing the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle.

For example, the secondary battery may include an electrode assembly including a cathode, an anode and a separation layer (separator), and an electrolyte immersing the electrode assembly. The secondary battery may further include an exterior material having, e.g., a pouch shape for accommodating the electrode assembly and the electrolyte.

After the electrode assembly is inserted into the exterior material, a sealing portion may be formed by sealing side portions of the exterior material. For example, sealant layers included in the exterior material facing each other may be fused by heating and pressing to form the sealing portion.

The electrode assembly may be expanded by repeated charging/discharging of the secondary battery. If an adhesive strength or a pressure resistance of the sealing portion is insufficient, the sealing portion may be disassembled or the pouch may be damaged.

Thus, developments of a secondary battery structure and a secondary battery processing method for obtaining sufficient pressure resistance and fusion strength are needed.

### SUMMARY

According to an aspect of the present disclosures, there is provided a secondary battery having improved stability and mechanical reliability.

According to an aspect of the present disclosures, there is provided an apparatus for processing a secondary battery having improved stability and mechanical reliability.

According to an aspect of the present disclosures, there is provided a method of manufacturing a secondary battery having improved stability and mechanical reliability. A secondary battery includes an electrode assembly including an electrode tab, and an exterior material accommodating the electrode assembly and including a sealing portion formed around the electrode assembly. The sealing portion includes a tab sealing portion formed at an area where the electrode tab is drawn out, and the tap sealing portion includes repeating patterns.

In some embodiments, the tab sealing portion may include grid patterns that are repeatedly arranged.

In some embodiments, the tab sealing portion may include a resin filling portion formed between the grid patterns.

In some embodiments, the secondary battery may further include a tab sealing film disposed between the tab sealing portion and the electrode tab.

In some embodiments, the tab sealing film may be at least partially included in the resin filling portion.

In some embodiments, the sealing portion may include an end sealing portion formed at an end portion of the exterior material where the electrode tab is drawn out, and a side sealing portion formed at a lateral side of the exterior material where the electrode tab is not drawn out. The side sealing portion may have a constant line shape that may not include repeating patterns.

In some embodiments, the end sealing portion may include the tab sealing portion and a margin sealing portion formed at both lateral sides of the tab sealing portion, and the margin sealing portion may have a constant line shape that may not include repeating patterns.

In some embodiments, the tab sealing portion may include an upper tab sealing portion and a lower tab sealing portion facing each other with the electrode tab interposed therebetween. Each of the upper tab sealing portion and the lower tab sealing portion may include the repeating patterns.

An apparatus for processing a secondary battery includes an upper sealing block, and a lower sealing block facing the upper sealing block with a gap therebetween. At least one of the upper sealing block and the lower sealing block has a tab pressing surface including grid pressing patterns.

In some embodiments, the tab pressing surface may include a lattice groove formed between the grid pressing patterns.

In some embodiments, at least one of the upper sealing block and the lower sealing block may have a rounded corner portion round-treated at an edge portion of the tab pressing surface.

In some embodiments, the gap may include a first sealing gap including the tab pressing surface and a margin gap smaller than the first sealing gap.

In some embodiments, the gap may further include a second sealing gap formed between the first sealing gap and the margin gap. The second sealing gap may be larger than the margin gap and smaller than the first sealing gap.

In a method of manufacturing a secondary battery, a preliminary battery cell including an electrode assembly and an exterior material accommodating the electrode assembly is prepared. Sealing blocks including a tab sealing gap in which grid pressing patterns are formed are aligned with a sealing portion of the preliminary battery cell. The sealing blocks are pressed onto the sealing portion to form a tab sealing portion.

In some embodiments, in the formation of the tab sealing portion, the grid pressing patterns of the sealing blocks may be transferred to the sealing portion as grid patterns.

In some embodiments, in the formation of the tab sealing portion, spaces between the grid patterns may be filled with a resin material of a sealant layer included in the exterior material.

A secondary battery according to example embodiments may include a pouch-shaped exterior material, and a tab sealing portion of the exterior material may include a repeating pattern formed using a sealing block that includes repeated pressing patterns. The repeating pattern may disperse a stress generated during expansion of the exterior material, thereby preventing damages of the exterior material and a release of sealing.

In some embodiments, the tab sealing portion may have a honeycomb or grid shape including grid patterns. A resin filling portion may be formed between the grid patterns. The resin filling portion may serve as a hurdle or a barrier to a gas generated in the exterior material. Accordingly, gas leakage from the tab sealing portion may be prevented, and sealing stability and reliability may be improved.

### BRIEF DESCRIPTION OF THE DRAWINGS

FIGS. 1 and 2 are a schematic plan view and a schematic cross-sectional view, respectively, illustrating a secondary battery in accordance with example embodiments.

FIG. 3 is a schematic cross-sectional view of an exterior material in accordance with example embodiments.

FIG. 4 is a schematic plan view illustrating a secondary battery in accordance with some example embodiments.

FIG. 5 is a schematic partially enlarged plan view illustrating a sealing portion of a secondary battery in accordance with example embodiments.

FIG. 6 is a schematic partially enlarged cross-sectional view illustrating a tab sealing portion of a secondary battery in accordance with example embodiments.

FIG. 7 is a schematic perspective view illustrating an apparatus for processing a secondary battery in accordance with example embodiments.

FIGS. 8 and 9 are a plan view and a cross-sectional view, respectively, illustrating a tab pressing surface of an apparatus for processing a secondary battery in accordance with example embodiments.

FIG. 10 is a schematic cross-sectional view illustrating a method of manufacturing a secondary battery an apparatus for processing a secondary battery in accordance with example embodiments.

### DETAILED DESCRIPTION OF THE EMBODIMENTS

According to embodiments of the present disclosures, a secondary battery including a tab sealing portion and providing improved stability and reliability and a method of manufacturing the secondary battery are provided. Further, an apparatus for processing a secondary battery capable of fabricating the tab sealing portion is provided.

Hereinafter, example embodiments according to the present disclosures will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “upper,” “lower,” “top,” “bottom,” herein are used to relatively distinguish positions of components, and are not intended to designate absolute positions.

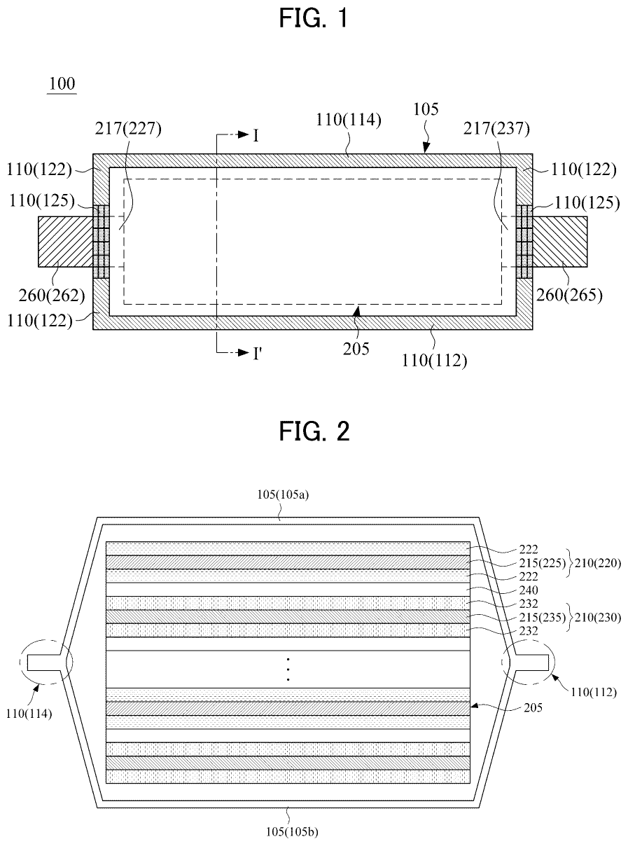

FIGS. 1 and 2 are a schematic plan view and a schematic cross-sectional view, respectively, illustrating a secondary battery in accordance with example embodiments. Specifically, FIG. 2 is a cross-sectional view taken in a thickness direction along a line I-I′ of FIG. 1.

Referring to FIGS. 1 and 2, the secondary battery 100 may include an exterior material 105 and an electrode assembly 205 accommodated in the exterior material 105. The electrode assembly 205 may include repeatedly stacked electrodes 210 and a separation 240 disposed between the electrodes 210. Each of the electrodes 210 may include an active material layer formed on an electrode current collector 215.

The electrodes 210 may include a cathode 220 and an anode 230. The electrode current collector 215 may include a cathode current collector 225 included in the cathode 220 and an anode current collector 235 included in the anode 230. The active material layer may include a cathode active material layer 222 included in the cathode 220 and an anode active material layer 232 included in the anode 230.

The cathode 220 may include a cathode current collector 225 and a cathode active material layer 222 formed by coating a cathode active material on the cathode current collector 225. The cathode active material may include a compound capable of reversibly intercalating and de-intercalating lithium ions. In this case, the secondary battery may be provided as a lithium secondary battery.

In example embodiments, the cathode active material may include lithium-transition metal composite oxide particles. For example, the lithium-transition metal composite oxide particles may include nickel (Ni), and may further include at least one of cobalt (Co) and manganese (Mn).

For example, the cathode current collector 225 may include stainless steel, nickel, aluminum, titanium, copper, zinc, or an alloy thereof. In an embodiment, the cathode current collector 225 may include aluminum or an aluminum alloy.

For example, a slurry may be prepared by mixing and stirring the cathode active material with a binder, conductive material and/or a dispersive agent in a solvent. The slurry may be coated on the cathode current collector 225, and then dried pressed to form the cathode 220 including the cathode active material layer 222.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer may be reduced, and an amount of the cathode active material may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 230 may include the anode current collector 235 and the anode active material layer 232 formed by coating an anode active material on a surface of the anode current collector 235.

The anode active material may include a material commonly used in the related art which may be capable of adsorbing and ejecting lithium ions. For example, a carbon-based material such as a crystalline carbon, an amorphous carbon, a carbon complex or a carbon fiber, a lithium alloy, a silicon-based active material, etc., may be used.

The amorphous carbon may include a hard carbon, cokes, a mesocarbon microbead (MCMB), a mesophase pitch-based carbon fiber (MPCF), etc. The crystalline carbon may include a graphite-based material such as natural graphite, graphitized coke, graphitized MCMB, graphitized MPCF, etc. The lithium alloy may further include aluminum, zinc, bismuth, cadmium, antimony, silicon, lead, tin, gallium, indium, etc.

The anode current collector 235 may include, e.g., gold, stainless steel, nickel, aluminum, titanium, copper, or an alloy thereof. In an embodiment, the anode current collector 235 may include copper or a copper alloy.

For example, a slurry may be prepared by mixing and stirring the anode active material with a binder, a conductive material and/or a dispersive agent in a solvent. The slurry may be coated on at least one surface of the anode current collector 235, and then dried and pressed to form the anode 230 including the anode active material layer 232.

The binder and the conductive material substantially the same as or similar to those used for the cathode active material layer 222 may also be used. In some embodiments, the binder for forming the anode may include an aqueous binder such as styrene-butadiene rubber (SBR) for a compatibility with the carbon-based active material, and carboxymethyl cellulose (CMC) may also be used as a thickener.

The separation layer 240 may be interposed between the cathode 220 and the anode 230. The separation layer 240 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 240 may also include a non-woven fabric formed from a glass fiber with a high melting point, a polyethylene terephthalate fiber, etc.

In example embodiments, the electrode assembly 205 may be defined by alternately and repeatedly stacking the cathode 220 and the anode 230 with the separation layer 240 interposed therebetween.

For convenience of illustration, the electrode assembly 205 is illustrated as a stacked type in FIG. 2. However, the electrode assembly 205 may have, e.g., a jelly-roll structure formed by winding or folding the separation layer 240.

In some embodiments, the electrode assembly 205 may be accommodated together with an electrolyte in the exterior material 105 to define a secondary battery. For example, as illustrated in FIGS. 1 and 2, a battery cell may be defined by the exterior material 105 and the electrode assembly 205 accommodated in the exterior material 105.

A non-aqueous electrolyte may be used as the electrolyte. The non-aqueous electrolyte may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

The electrode current collector 205 may include an electrode tab 217. The electrode tab 217 may include a cathode tab 227 protruding from the cathode current collector 225 and an anode tab 237 protruding from the anode current collector 235.

An electrode lead 260 may be electrically connected to the electrode tab 217 and may be exposed to an outside of the exterior material 105. The electrode lead 260 may serve as an external connection lead for applying a power to the secondary battery.

The electrode lead 260 may be fused together with a periphery portion of the exterior material 105. In some embodiments, as illustrated in FIG. 1, a cathode lead 262 and an anode lead 265 may be disposed at both peripheral portions of the secondary battery facing each other. In one embodiment, the cathode lead 262 and the anode lead 265 may be fused together at one peripheral portion of the exterior material 105.

For example, the exterior material 105 may include a pouch. The electrode assembly 205 may be accommodated in the exterior material 105 and the peripheral portion of the exterior material 105 may be sealed to form a sealing portion 110.

As illustrated in FIG. 2, the exterior material 105 may include an upper pouch 105a and a lower pouch 105b, and the sealing portion 110 may be formed by fusing the peripheral portions of the upper pouch 105a and the lower pouch 105b.

As illustrated in FIG. 1, the sealing portion 110 may include a side sealing portion 112 and 114, and an end sealing portion 122. The side sealing portions 112 and 114 may include both lateral side portions in a width direction of the exterior material 105 from which the electrode lead 260 and the electrode tab 217 are not drawn out. For example, the side sealing portions 112 and 114 may include a first side sealing portion 112 and a second side sealing portion 114 facing each other in the width direction.

The end sealing portion 122 may be formed at both end portions of the exterior material 105 in a longitudinal direction, and the electrode lead 260 or the electrode tab 217 may be drawn out through the end sealing portion 122.

The electrode tab 217 and the exterior material 105 may be fused or sealed together at the end sealing portion 122. In one embodiment, the electrode lead 260, the electrode tab 217 and the exterior material 105 may be fused or sealed together at the end sealing portion 122. Accordingly, the end sealing portion 122 may include a tab sealing portion 125 including the electrode tab 217.

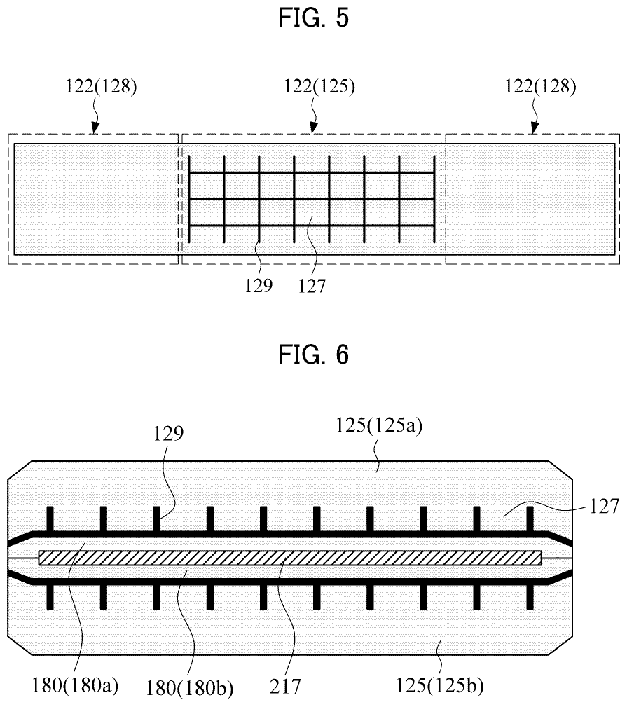

In example embodiments, the tab sealing portion 125 may include repeating patterns. The shape and structure of the repeating patterns will be described later in detail with reference to FIGS. 5 and 6.

In some embodiments, portions of the sealing portion 110 except for the tab sealing portion 125 may have a continuous line shape in which repeating patterns are not formed.

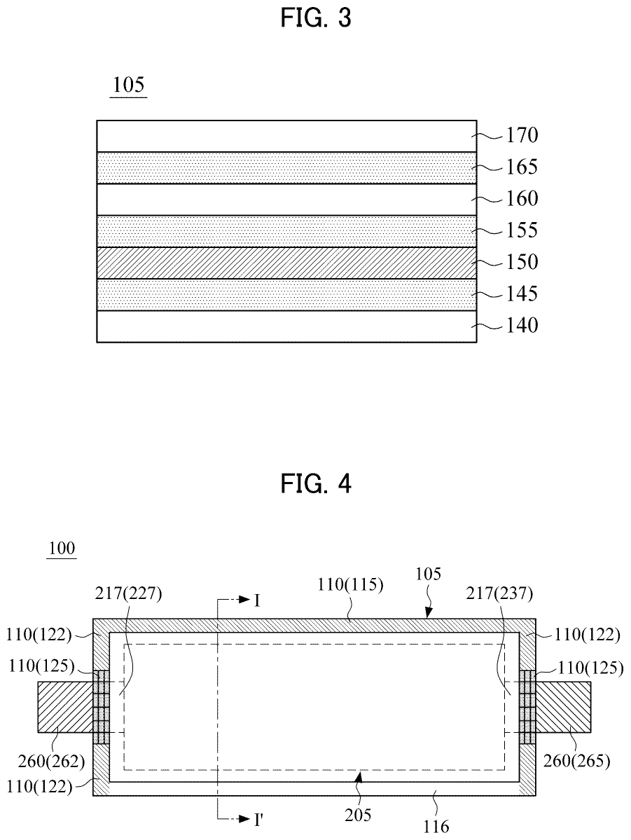

FIG. 3 is a schematic cross-sectional view of an exterior material in accordance with example embodiments. For example, FIG. 3 is a cross-sectional view for describing a laminated structure of the exterior material 105.

Referring to FIG. 3, the exterior material 105 may include a metal layer 150, a sealant layer 140 disposed on a bottom surface of the metal layer 150, and substrate layers 160 and 170 disposed on a top surface of the metal layer 150.

The bottom surface of the metal layer 150 may face an inside of the secondary battery 100 or the battery cell, and the top surface of the metal layer 150 may face an outside of the secondary battery 100 or the battery cell.

The metal layer 150 may serve as a barrier providing a resistance to moisture permeability, chemical resistance, gas barrier properties, etc., of the exterior material 105. For example, the metal layer 150 may be formed of a metal foil such as aluminum foil.

The sealant layer 140 may be a layer exposed to the inside of the battery cell. The sealant layer 140 may be a melted and adhered portion by a sealing process including a fusion process after accommodating the electrode assembly 205 within the exterior material 105. For example, as illustrated in FIG. 2, the sealant layers 140 included in the upper pouch 105a and the lower pouch 105b may be fused to each other to form the sealing portion 110.

For example, the sealant layer 140 may include a polyolefin-based resin or a cyclic polyolefin-based resin. Examples of the polyolefin-based resin include polyethylene, polypropylene, a block copolymer of polypropylene (e.g., a block copolymer of propylene and ethylene), a random copolymer of polypropylene (e.g., a random copolymer of propylene and ethylene), a terpolymer of ethylene-butene-propylene, etc.

The substrate layer may include an intermediate substrate layer 160 and an outer substrate layer 170. The intermediate substrate layer 160 and the outer substrate layer 170 may be sequentially stacked from the top surface of the metal layer 150.

The substrate layer may include a polyester resin, a polyamide resin, an epoxy resin, an acrylic resin, a fluorine resin, a polyurethane resin, a silicon resin, a phenol resin, or a mixture or a copolymer thereof.

Examples of the polyester resin include polyethylene terephthalate, polybutylene terephthalate, polyethylene naphthalate, polybutylene naphthalate, a copolymerized polyester, polycarbonate, etc. Examples of the polyamide resin include nylon 6, nylon 6,6, a copolymer of nylon 6 and nylon 6,6, nylon 6,10, polymethaxylylene adipamide (MXD6), etc.

For example, the intermediate substrate layer 160 may include a polyamide resin such as nylon, and the outer substrate layer 170 may include the polyester resin such as polyethylene terephthalate (PET).

The above-mentioned layers or films may be bonded to each other through an adhesive layer. The intermediate substrate layer 160 and the outer substrate layer 170 may be bonded to each other by a first adhesive layer 165. The metal layer 150 and the intermediate substrate layer 160 may be bonded to each other by a second adhesive layer 155. The metal layer 150 and the sealant layer 140 may be bonded to each other by a third adhesive layer 145.

FIG. 4 is a schematic plan view illustrating a secondary battery in accordance with some example embodiments. Detailed descriptions of elements and structures substantially the same as or similar to those described with reference to FIGS. 1 to 3 are omitted.

Referring to FIG. 4, the sealing portion 110 of the exterior material 105 may include a side sealing portion 115 at one lateral side in the width direction. The exterior material 105 may include a folding portion 116 that may face the side sealing portion 115 in the width direction.

For example, the upper pouch 105a and the lower pouch 105b may be integrally connected by the folding portion 116. In this case, the exterior material 105 or the secondary battery 100 may have a three-sided sealing structure.

FIG. 5 is a schematic partially enlarged plan view illustrating a sealing portion of a secondary battery in accordance with example embodiments. FIG. 6 is a schematic partially enlarged cross-sectional view illustrating a tab sealing portion of a secondary battery in accordance with example embodiments.

Referring to FIG. 5, as described above, the end sealing portion 122 may be formed at the end portion of the exterior material 105 or the secondary battery 100 in the length direction, and the end sealing portion 122 may include the tab sealing portion 125. Margin sealing portions 128 may be formed at both sides of the tab sealing portion 125 in the end sealing portion 122.

As described above, the tab sealing portion 125 of the exterior material 105 may include the repeating patterns. The repeating patterns may face the inside of the exterior material 105 and may be disposed to face the electrode tab 217.

In some embodiments, the tab sealing portion 125 may include grid patterns 127 that are repeatedly arranged. Accordingly, the tab sealing portion 125 may have a honeycomb shape or a grid shape in a plan view.

As shown in FIG. 5, each of the grid patterns 127 may have a rectangular shape in the plan view. The shape of the grid patterns 127 may be appropriately modified into a shape such as a triangle, a pentagon, a circle, an ellipse, etc.

A resin filling portion 129 may be formed between the grid patterns 127. In example embodiments, a resin material included in the sealant layer 140 described with reference to FIG. 3 may be pushed into a space between the grid patterns 127 by a pressing pressure to for the resin filling portion 129.

For example, the resin filling portion 129 may include a polyolefin-based resin such as polyethylene, polypropylene, a block copolymer of polypropylene, a random copolymer of polypropylene, a terpolymer of ethylene-butene-propylene, etc.

Referring to FIG. 6, the tab sealing portion 125 may include an upper tab sealing portion 125a and a lower tab sealing portion 125b. The upper tab sealing portion 125a and the lower tab sealing portion 125b may be included in the upper pouch 105a and the lower pouch 105b, respectively.

The electrode tab 217 may be interposed between the upper tab sealing portion 125a and the lower tab sealing portion 125b, and may be fused together with the upper tab sealing portion 125a and the lower tab sealing portion 125b by an apparatus for processing a secondary battery as described below.

As described above, the tab sealing portion 125 may include the grid patterns 127 that are repeatedly arranged, and the resin filling portion 129 may be formed between the grid patterns 127.

The exterior material 105 and the electrode tab 217 (or the electrode lead 260) may be fused together In the tab sealing portion 125, and thus a stepped portion may be caused by the electrode tab 217 (or the electrode lead 260). Further, an insulating material and a metallic material may be fused together in the tab sealing portion 125, and thus peeling between layers may occur more easily than in an area of the sealing portion 110 excluding the tab sealing portion 125.

Accordingly, gas generated by repeated charging/discharging of the secondary battery 100 may be leaked from the tab sealing portion 125 to cause an explosion or an ignition. For example, as the electrode assembly 205 expands due to the repeated charging/discharging, a gas vent may easily occur in the tab sealing portion 125.

However, according to the above-described embodiments, stress due to an expansion pressure may be dispersed by the repeated pattern shape in the tab sealing portion 125. Accordingly, sufficient pressure resistance properties may be achieved through the tab sealing portion 125.

Additionally, the resin filling portion 129 formed between the grid patterns 127 may serve as a gas barrier. Thus, the gas vent may be suppressed or delayed, so that stability and life-span properties of the secondary battery 100 may be improved.

In some embodiments, the resin material included in the sealant layer 140 may extend to a sealing surface (an inner surface) of the tab sealing portion 125 while being included in the resin filling part 129. Thus, an adhesive strength with the electrode tab 217 may be sufficiently obtained.

As illustrated in FIG. 6, the tab sealing portion 125 may further include a tab sealing film 180.

For example, an upper tab sealing film 180a may be disposed between the upper tab sealing portion 125a and the electrode tab 217, and a lower tab sealing film 180b may be disposed between the lower tab sealing portion 125b and the electrode tab 217.

Adhesion and gas vent suppression of the tab sealing portion 125 may be further enhanced by the tab sealing film 180. In some embodiments, a resin component included in the tab sealing film 180 may also be included in the resin filling part 129. For example, an adhesive resin material included in the tab sealing film 180 may also be included in the resin filling portion 129.

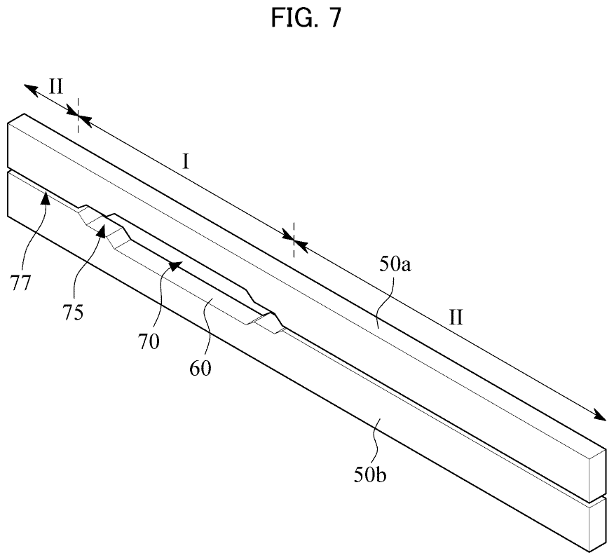

FIG. 7 is a schematic perspective view illustrating an apparatus for processing a secondary battery in accordance with example embodiments. For example, the apparatus for processing a secondary battery may serve as a sealing tool for a secondary battery. For convenience of descriptions, grid pressing patterns included in a tab pressing surface 60 is omitted in FIG. 7.

Referring to FIG. 7, the apparatus for processing a secondary battery (hereinafter, abbreviated as a processing apparatus) may include an upper sealing block 50a and a lower sealing block 50b. The upper sealing block 50a and the lower sealing block 50b may each include a tab region I and a margin region II.

The tab sealing portion 125 and the margin sealing portion 128 of the secondary battery 100 may be formed by the tab region I and the margin region II of the processing apparatus, respectively.

The processing apparatus may include tab sealing gaps 70 and 75 in the tab region I. For example, a gap for forming the sealing portion 110 of the exterior material 105 may be formed between the upper sealing block 50a and the lower sealing block 50b facing each other.

A substantially constant margin gap 77 may be maintained in the margin region II. The gap in the tab region I may be larger than the margin gap 77 to form the tab sealing gaps 70 and 75.

The tab sealing gaps 70 and 75 may include a first sealing gap 70 and a second sealing gap 75. The first sealing gap 70 may be larger than the second sealing gap 75.

In example embodiments, as described with reference to FIG. 6, the sealing portion 110 and the electrode tab 217 of the exterior material 105 may be inserted into the first sealing gap 70 and may be pressed. In some embodiments, the tab sealing film 180 may also be inserted and pressed into the first sealing gap 70.

In some embodiments, the electrode tab 217 may be excluded from the second sealing gap 75, and the sealing portion 110 of the exterior material 105 and the tab sealing film 180 may be inserted and pressed together in the second sealing gap 75.

For example, gap sizes of the margin gap 77, the second sealing gap 75 and the first sealing gap 70 may sequentially increase along a length direction of the processing apparatus. The margin gap 77, the second sealing gap 75, the first sealing gap 70, the second sealing gap 75 and the margin gap 77 may be sequentially and continuously formed in the processing apparatus.

The first sealing gap 70 may be defined between the tab pressing surfaces 60 facing each other. For example, the upper sealing block 50a and the lower sealing block 50b each include the tab pressing surface 60 in the tab region I, and the tab pressing surfaces 60 may face each other with the first sealing gap 70 interposed therebetween.

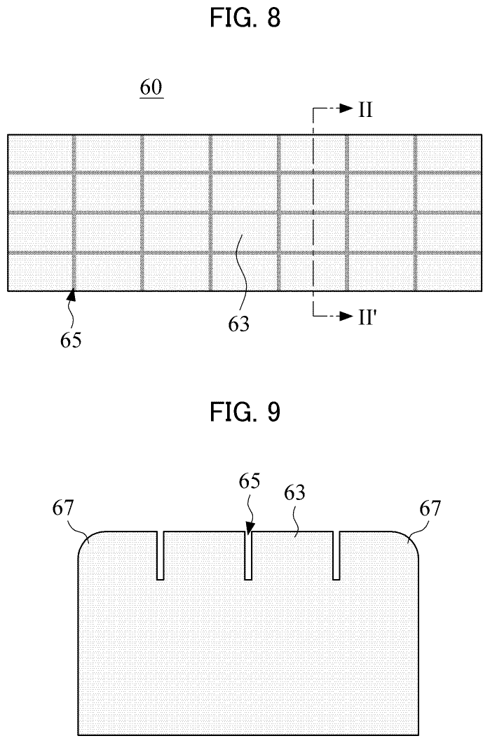

FIGS. 8 and 9 are a plan view and a cross-sectional view, respectively, illustrating a tab pressing surface of an apparatus for processing a secondary battery in accordance with example embodiments. For example, FIG. 9 is a cross-sectional view taken along a line II-II′ of FIG. 8 in a thickness direction.

Referring to FIGS. 8 and 9, the sealing blocks 50a and 50b may each include the tab pressing surface 60 corresponding to an exposed surface or an inner surface of the first sealing gap 70 included in the tab region I.

The tab pressing surface 60 may include grid pressing patterns 63. The grid pressing patterns 63 may be spaced apart by a grid grove 65.

As illustrated in FIG. 9, edge portions of the sealing blocks 50a and 50b in the width direction in the tab region I may be round-treated. Accordingly, the sealing blocks 50a and 50b may include a rounded corner portion 67 in the tab region I. Mechanical damages such as tearing of the outer material 105 at the tab sealing portion 125 may be prevented by the rounded corner portion 67.

The sealing blocks 50a and 50b may include a metal, a ceramic or a polymer. In one embodiment, the sealing blocks 50a and 50b may include the metal in consideration of efficiency of the sealing process by a heat pressing.

In some embodiments, sealing surfaces or facing surfaces of the sealing blocks 50a and 50b in the margin region II may not include the grid pressing patterns 63. For example, the sealing surfaces or facing surfaces of the sealing blocks 50a and 50b in the margin region II may have substantially seamless or flat surfaces.

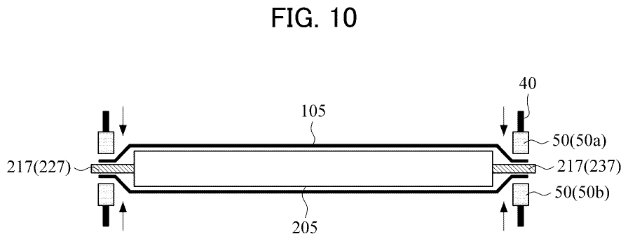

FIG. 10 is a schematic cross-sectional view illustrating a method of manufacturing a secondary battery an apparatus for processing a secondary battery in accordance with example embodiments.

Referring to FIG. 10, the electrode assembly 205 may be accommodated in the exterior material 105 to prepare a preliminary battery. The electrolyte solution may be accommodated in the exterior material 105 together with the electrode assembly 205.

The electrode tab 217 included in the electrode assembly 205 may be inserted into the first sealing gap 70 of the processing apparatus described with reference to FIGS. 7 to 9 together with the end portion of the exterior material 105.

Thereafter, the upper sealing block 50a and the lower sealing block 50b may be pressed toward the electrode tab 217 to form the tab sealing portion 125. The margin sealing portion 128 may also be formed at both lateral sides of the tab sealing portion 125 and the end sealing portions 122 may also be formed by the pressing.

A moving tool 40 may be coupled to the sealing blocks 50a and 50b. A pressing pressure may be applied by moving the sealing blocks 50a and 50b upward and downward using the moving tool 40.

In example embodiments, the grid pressing patterns 63 included in the tab pressing surfaces 60 of the sealing blocks 50a and 50b may be transferred to the grid patterns 127 of the tab sealing portion 125 by the pressing. The resin filling portion 129 may be formed at a position corresponding to the lattice groove 65 included in the tab pressing surface 60.

The side sealing portions 112 and 114 (see FIG. 1) may be formed through a pressing process using bar-shaped sealing blocks which are spaced at substantially constant interval and do not include grid pressing patterns.

The battery cell or the secondary battery 100 having the sealing portion 110 may be obtained through the above-described pressing process.

What is claimed is:

1. A secondary battery, comprising:
an electrode assembly comprising an electrode tab; and
an exterior material accommodating the electrode assembly and comprising a sealing portion formed around the electrode assembly,
wherein the sealing portion comprises a tab sealing portion formed at an area where the electrode tab is drawn out, and the tap sealing portion comprises repeating patterns.

2. The secondary battery of claim 1, wherein the tab sealing portion comprises grid patterns that are repeatedly arranged.

3. The secondary battery of claim 2, wherein the tab sealing portion comprises a resin filling portion formed between the grid patterns.

4. The secondary battery of claim 3, further comprising a tab sealing film disposed between the tab sealing portion and the electrode tab.

5. The secondary battery of claim 4, wherein the tab sealing film is at least partially included in the resin filling portion.

6. The secondary battery of claim 1, wherein the sealing portion comprises an end sealing portion formed at an end portion of the exterior material where the electrode tab is drawn out, and a side sealing portion formed at a lateral side of the exterior material where the electrode tab is not drawn out, and
wherein the side sealing portion has a constant line shape that does not include repeating patterns.

7. The secondary battery of claim 6, wherein the end sealing portion comprises the tab sealing portion and a margin sealing portion formed at both lateral sides of the tab sealing portion, and
the margin sealing portion has a constant line shape that does not include repeating patterns.

8. The secondary battery of claim 1, wherein the tab sealing portion comprises an upper tab sealing portion and a lower tab sealing portion facing each other with the electrode tab interposed therebetween, and
wherein each of the upper tab sealing portion and the lower tab sealing portion comprises the repeating patterns.

9. An apparatus for processing a secondary battery, comprising:
an upper sealing block; and
a lower sealing block facing the upper sealing block with a gap therebetween,
wherein at least one of the upper sealing block and the lower sealing block has a tab pressing surface comprising grid pressing patterns.

10. The apparatus for processing a secondary battery of claim 9, wherein the tab pressing surface comprises a lattice groove formed between the grid pressing patterns.

11. The apparatus for processing a secondary battery of claim 9, wherein at least one of the upper sealing block and the lower sealing block has a rounded corner portion round-treated at an edge portion of the tab pressing surface.

12. The apparatus for processing a secondary battery of claim 9, wherein the gap comprises a first sealing gap including the tab pressing surface and a margin gap smaller than the first sealing gap.

13. The apparatus for processing a secondary battery of claim 12, wherein the gap further comprises a second sealing gap formed between the first sealing gap and the margin gap, and
the second sealing gap is larger than the margin gap and smaller than the first sealing gap.

14. A method of manufacturing a secondary battery, comprising:
preparing a preliminary battery cell comprising an electrode assembly and an exterior material accommodating the electrode assembly;
aligning sealing blocks comprising a tab sealing gap in which grid pressing patterns are formed with a sealing portion of the preliminary battery cell; and
pressing the sealing blocks onto the sealing portion to form a tab sealing portion.

15. The method of claim 14, wherein the formation of the tab sealing portion comprises transferring the grid pressing patterns of the sealing blocks to the sealing portion as grid patterns.

16. The method of claim 15, wherein the formation of the tab sealing portion comprises filling spaces between the grid patterns with a resin material of a sealant layer included in the exterior material.
